(19) United States
(12) Patent Application Publication
(10) Pub. No.: US 2025/0061344 A1
(43) Pub. Date: Feb. 20, 2025

(54) CO-PILOTS FOR ENHANCED ACCESS TO DEVOPS BASED KNOWLEDGE AND RELATED SYSTEMS AND METHODS

(71) Applicant: RAILTOWN AI TECHNOLOGIES INC., Burnaby (CA)

(72) Inventors: Marwan HADDAD, Surrey (CA); Elliot HOLTHAM, West Vancouver (CA); Jaime BUEZA, Surrey (CA); Ali BOUZARI, Vancouver (CA); Jackson FRASER, Vancouver (CA); Guan Zheng HUANG, Richmond (CA)

(21) Appl. No.: 18/807,268

(22) Filed: Aug. 16, 2024

Related U.S. Application Data
(60) Provisional application No. 63/520,531, filed on Aug. 18, 2023.

(51) Int. Cl. G06N 5/01; G06N 5/022

(52) U.S. Cl. CPC G06N 5/01; G06N 5/022

(57) ABSTRACT

Systems and methods allow users to query a software-application-based knowledge base to retrieve information. The user creates queries and the specified information is returned through a user interface. In alternative embodiments, the system is able to create follow-up queries independent from or directed by the user. Such embodiments may also provide critical information related to the original query. The knowledge base contains information about the application and is able to provide the appropriate answer to user queries through machine-learning-based tools, such as large language models (LLMs) or other natural language processing (NLP) based techniques.

### FIELD

This invention relates to systems, tools and methods useful for provide enhanced access to specialized knowledge. The invention has example application in the field of software development and maintenance. One aspect of the invention provides co-pilot-based tools that facilitate access to information of diverse types that relate to a common undertaking such as a project, software application, operation of a team or the like.

### BACKGROUND

Development and operations (DevOps) may be described as a set of practices, methodologies, and implementations of development (Dev) and operations (Ops) into a continuous process. DevOps encapsulates practices which facilitate an overall project, as well as team progress management, in virtually any area requiring coordination between development or creative activities and operational tasks.

DevOps practices have example application in computer software development and maintenance. During the development, execution, and maintenance of software applications, a substantial amount of information and data is generated. As a software application is developed and maintained, it is typical to create a unique data snapshot at each modification of the application. These snapshots may include a wide variety of information related to the application as of a given moment in time.

Over time, as a software application continues to run and as software or deployment modifications are made, more and more information is acquired. This information is typically stored in diverse datasets which typically each possess a temporal component.

A dataset may contain information about all previous states of the application. For example, each time a new set of data that is relevant to a particular dataset is created, the new data may be appended to the dataset. In this manner the data set may be made to include the relevant information about the current build of an application as well as all previous builds of the application.

The collection of datasets relating to an application can include diverse types of data including: source code (potentially developed using various programming languages); application logs, and software development work-item-related information, also known as ticket information. Application logs offer valuable insights into an application's runtime behaviours, such as performance, error occurrences, and overall runtime. Work-item-related information encompasses development progress, planning, decision-making, and descriptions relevant to the application. The datasets associated with an application may contain deployment and build data, as well as related work items and documentation.

A very large amount of data may be generated over time as development and eventually deployment and maintenance of an application proceeds. This data may be spread across several different systems and may be of multiple different types. In order to effectively perform their work, team members may require specific information relating to the application. It is a problem that it can be time consuming and inefficient to locate specific information that may be required to complete a task.

As an application becomes larger and team size grows, it is virtually impossible for any single person to possess complete knowledge of the application. This is further complicated when, for example, an employee who wrote portions of the code leaves a project and the team no longer has access to that employee's insights. Over time, it becomes increasingly difficult for a team to be familiar with the entirety of the application, and the complete history of builds. This is a particular problem for long-lived applications that may be maintained for years, if not decades.

Tools for working with individual data streams exist. Examples of such tools include Jira™, for ticket or work item management; GitHub™ or BitBucket™, for code management and version control; as well as Logly™, for log analysis and application monitoring. Each of these tools has the ability to query application data in various ways, such as searching for tickets created within a specific date range.

The inventors have recognized a need for systems, tools and methods which will provide access to diverse information relating to an undertaking. The inventors have recognized a particular need for such systems tools and methods in the field of computer software development and maintenance. Such systems, tools and methods can improve efficiency of teams of computer software professionals by facilitating enhanced access to data of diverse types that is relevant to a software application.

### SUMMARY

The present invention has a number of aspects. These include, without limitation:
knowledge-based co-pilot systems for assisting software development teams to efficiently access and/or process information relating to software applications, software development, and/or performance of software development teams and their members;
machine implemented methods for assisting software development teams to efficiently access and/or process information relating to software applications, software development, and/or performance of software development teams and their members.
apparatus and methods for retrieving structured and unstructured data (sometimes referred to herein as “structured information” and “unstructured information” respectively) in response to user questions (also described herein as “requests” or “user queries” or “queries”).

An example aspect of the invention provides an automated system for responding to user questions based on information from one or more knowledge bases. The system comprises one or more data processors configured to provide a machine learning model. The machine learning model is configured to receive user questions and, in response to each user question: determine whether answering the user question requires unstructured data from the one or more knowledge bases and determining whether answering the user question requires structured data from the one or more knowledge bases; if the machine learning model determines that answering the user question requires structured data, generating a search strategy including at least one search query for retrieving from the one or more knowledge bases structured data relevant to the user question. The system also includes at least one database system (sometimes referred to herein as a “database”) and at least one vector search system (sometimes referred to herein as a “vector database”). The database system is controlled (e.g. by computer software that executes on the one or more data processors) to, in response to the determination that answering the user question requires structured data, execute the search strategy to retrieve a set of data items that satisfy the search strategy from the one or more knowledge bases. The vector search system is controlled (e.g. by computer software that executes on the one or more data processors) to, in response to the determination that answering the user question requires unstructured data, perform a vector search of unstructured data included in data items in the one or more of the knowledge bases, generate similarity scores that indicate a degree of similarity of the unstructured data in the data items to the user question and retrieve a set of data items for which the similarity scores satisfy a criterion. A response generator is configured to generate and output an answer to the user question based on the set of data items that satisfy the search strategy if the machine learning model determined that answering the user question requires structured data and based on the set of data items for which the similarity scores satisfy a criterion if the machine learning model determined that answering the user question requires unstructured data.

In some embodiments the machine learning model comprises a large language model (LLM).

In some embodiments the machine learning model is configured to output an unstructured data indication in response to determining that answering the user question requires unstructured data.

In some embodiments the unstructured data indication comprises a command included in the search strategy.

In some embodiments he response generator comprises a second machine learning model and the answer to the question is a natural language answer. In some embodiments the second machine learning model comprises a LLM.

In some embodiments the search strategy comprises a sequence of search queries. In some embodiments the sequence of search queries includes a search query that comprises one or more results from a result set of a previous search query in the sequence of search queries.

In some embodiments the database system is configured to use the similarity scores to sort the data items of the set of data items retrieved by the database system. In some embodiments, the similarity scores comprise cosine similarity scores.

In some embodiments the one or more search query. comprises one or more Structured Query Language (SQL) queries.

In some embodiments the vector search is performed on the data items of the set of data items retrieved by the database system. In some embodiments the data items retrieved by the database system are in a SQL table.

In some embodiments the vector search system is operated to add the similarity scores to a SQL table.

In some embodiments the knowledge bases comprise one or more of: a dataset containing tickets and work items, a dataset containing application logs, a dataset containing build information, a dataset containing environment information, a dataset that contains software library information, a dataset containing source code, and a dataset containing information regarding compute resources. a work item knowledge base and a technical document knowledge base.

In some embodiments the knowledge bases contain data items that relate to development of a computer software application. In some embodiments the data items of the knowledge bases include a complete history of the state of the software application and all work done in the development and maintenance of the software application i

In some embodiments the user questions are provided in natural language. In some embodiments the user questions relate to DevOps.

In some embodiments the system is configured to generate summaries of data items in the one or more knowledge bases. In some embodiments the database system and/or the vector search system are configured to conduct searches on the summaries of the data items.

In some embodiments the system is configured to normalize a style and/or language of data items of the data sources.

In some embodiments, if the machine learning model determines that answering the user question requires structured data and unstructured data, the vector search system and the database system search are controlled to perform the vector search and to execute the search strategy in parallel.

In some embodiments the system is configured to pass a number, n, of data items of the a set of data items for which the similarity scores satisfy a criterion to the response generator.

In some embodiments, the one or more data processors are configured to coordinate operation of the system to generate user questions by prompting the machine learning model to generate the search query to retrieve relevant information and, in response to the search query and an indication regarding whether or not a vector search should be performed, controlling the database system and/or the vector search system to retrieve the relevant information from one or more of the knowledge bases. Controlling the vector search system may comprise embedding the user question according to an embedding model and providing the embedded user question to the vector search system. In some embodiments the prompt includes one or more of a description of the task, information about the SQL table to filter, some basic information about the data, and the input query (user question) for which to retrieve the information.

Another example aspect of the invention provides a machine executed method for automated response to user questions with information from one or more knowledge bases. The method comprises: receiving a user question, in response to each user question, automatically determining using a trained machine learning model whether answering the user question requires unstructured data from the one or more knowledge bases and determining whether answering the user question requires structured data from the one or more knowledge bases. if answering the user question requires structured data, generating a search strategy including at least one search query for retrieving from the one or more knowledge bases structured data relevant to the user question and executing the search strategy to retrieve a set of data items that satisfy the search strategy from the one or more knowledge bases; if answering the user question requires unstructured data, embedding the user question and performing a vector search of unstructured data included in data items in the one or more of the knowledge bases, generating similarity scores that indicate a degree of similarity of the unstructured data in the data items to the embedded user question and retrieving a set of data items for which the similarity scores satisfy a criterion; generating an answer to the user question based on the set of data items that satisfy the search strategy and/or the set of data items for which the similarity scores satisfy a criterion.

Another aspect of the invention provides apparatus comprising any new and inventive feature, combination of features or sub-combination of features as described herein.

Another aspect for the invention provides machine implemented methods that comprise any new and inventive, step, act, combination of steps and/or acts or sub-combination of steps and/or acts as described herein.

It is emphasized that the invention relates to all combinations of the above features, even if these are recited in different claims.

### BRIEF DESCRIPTION OF THE DRAWINGS

The accompanying drawings illustrate non-limiting example embodiments of the invention.

FIG. 1 is a high level block diagram for a co-pilot system according to one example embodiment of the present technology that works with data from an example set of data sources.

FIG. 2 is a high level architecture diagram of a system and associated methods according to an example embodiment of the present technology.

FIG. 3 is a flow chart that shows how historical chat history may be integrated with new query questions.

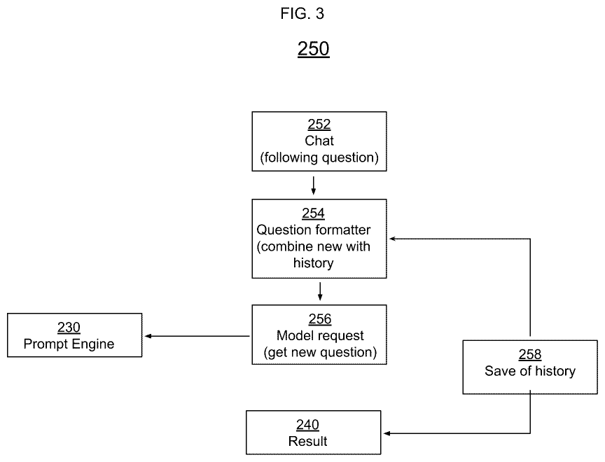

FIG. 4 is a view of the knowledge-based system co-pilot in an embodiment which responds to user queries.

FIG. 5 shows how the user interacts with the system through hardware devices

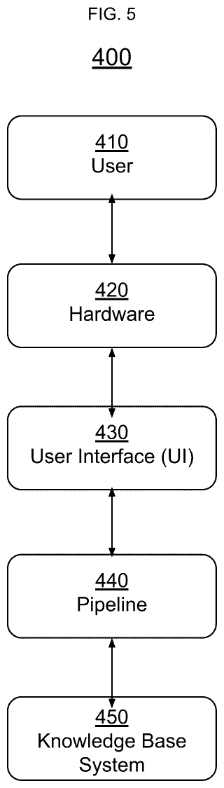

FIG. 6 is a view of an example knowledge base system.

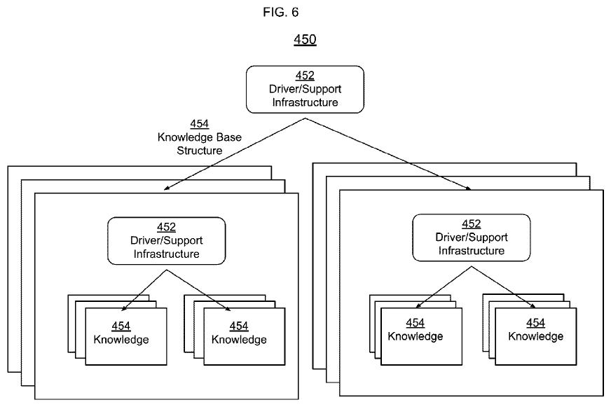

FIG. 7 shows how the SQL or vector database approach may be used for processing user input queries.

FIG. 8 shows how a user query is embedded into a vector database system.

FIG. 9 shows how the most relevant information is selected based on the ticket summaries and descriptions.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

Aspects of the present technology use artificial intelligence tools to provide insights derived from collections of data that relate to specific projects and/or teams. Some embodiments of the present technology use artificial intelligence (“AI”) to assist in accessing and using a diverse aggregation of data that is relevant to a software application to better understand the software application and/or steps to be taken to develop and/or maintain the software application and/or the team responsible for developing and/or maintain the software application. In such an environment the Al may be configured to provide developers and team members with insights across the entire software development process.

An example application of the present technology integrates Al tools into a DevOps framework. The Al tools may be configured to automate tasks within the DevOps framework and/or to locate, format and present to users relevant information drawn from diverse data sources relating to an undertaking such as development and/or maintenance of a software application.

The following detailed description explains example embodiments of the present technology in the form of a knowledge-based co-pilot system which can be applied to assist with DevOps management processes. The present technology also has application in other fields which involve working with unique and evolving datasets. Examples of such other fields are research and development and hardware design and fabrication.

The knowledge-based co-pilot system comprises a digital software entity which embeds within itself a number of knowledge bases. Each of the knowledge bases contains unique information. Depending on its embodiment, the system may specialize in a particular type of knowledge and/or provide general applications.

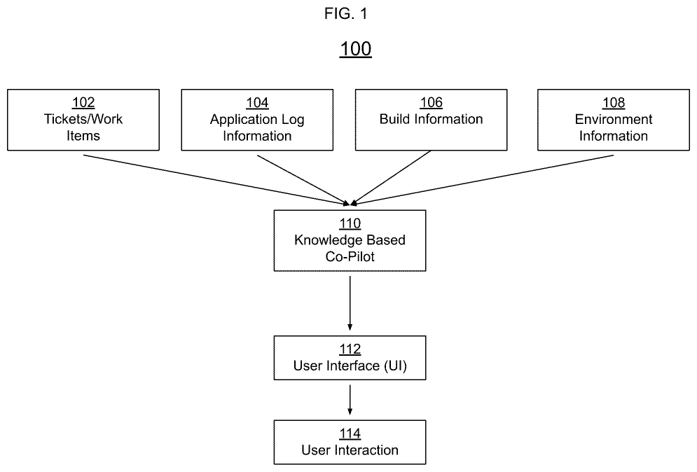

FIG. 1 shows an example co-pilot system 100 that includes a co-pilot 110. Co-pilot 110 is a knowledge base system. Co-pilot 110 functions to generate outputs (which may take any of many forms) in response to requests (also described herein as “user questions” or “user queries”). A request may, for example ask for information from one or more knowledge bases (such information is also described herein as “data items”. A data item may be a discrete piece of information such as a date, User ID, etc. or an item that combines various data such as a ticket which may include various structured data as well as various unstructured data) or performance of a task. Co-pilot 110 may apply various Al systems and methods, such as Natural Language Processing (NLP), Large Language Models (LLMs), and KNN (K-Nearest Neighbors) search methods for data normalization or queries to produce the requested outputs.

In some embodiments, including system 100, co-pilot 110 creates a knowledge base system by ingesting information in real-time from different datasets. These data sets can include but are not limited to, the examples provided in system 100, which includes a dataset 102 containing tickets and work items, a dataset 104 containing application logs, a dataset 106 containing build information and a dataset 108 containing environment information. Some embodiments may ingest data from other datasets that contain software library information, and/or other information relating to the creation and running of an application, such as a dataset containing source code and a dataset containing information regarding compute resources.

A system 100 may be configured to handle any of a range of tasks, dependent on the specific knowledge bases and contained data available, as well as user requirements.

System 100 includes a user interface (“UI”) 112 which is configured to receive requests of co-pilot 110 from users and to deliver output from co-pilot 110 to users. Requests (e.g. queries. user questions) from users and outputs created by co-pilot 110 are collectively identified as user interactions 114 in FIG. 1.

In some embodiments, UI 112 is designed to process and respond to a user's natural language queries by leveraging knowledge pertaining to syntax, semantics, and context stored in a text-analyzing knowledge base. In some embodiments the text analyzing knowledge base is specialized to a particular field of technology (e.g. software development), and may be further specialized to a particular company, team or software application.

The information that is ingested by co-pilot 110 may be updated and added to periodically and/or continuously as work on an undertaking (e.g. development and/or maintenance of a software application) proceeds.

In some embodiments, co-pilot 110 is self-maintained through regular updates. Updates can be completed via automated data pipelines or manual triggers of the entire system and methods. Updates may modify underlying knowledge bases and information contained within those knowledge bases. In this way, as work continues, the knowledge bases of co-pilot 110 can be kept up-to date in real time or near real time such that co-pilot 110 is aware of the current state of a software application as well as the current state of work being performed to develop and/or maintain the software application. Co-pilot 110 may also maintain a complete history of the state of the software application and all work done in the development and maintenance of the software application in its knowledge bases.

In some embodiments, the timing of updates (or “refreshes”) to some or all knowledge bases maintained by co-pilot 110 are performed at times that are based on the unique frequency of use associated with different knowledge bases. For example co-pilot 110 may include parameters that can be set by a user to strategically adjust the refresh rate or the triggers for updating knowledge bases of co-pilot 110 for each dataset (e.g. 102, 104, 106, 108 etc.) and/or for each knowledge base. This may facilitate keeping co-pilot 110 ready to produce outputs according to specific requirements while reducing the overhead associated with updating the knowledge bases of co-pilot 110 more frequently than necessary.

In some embodiments, co-pilot 110 is configured to trigger refreshes based on changes to the information in certain datasets (e.g. 102, 104, 106, 108 etc.) based on the discretion of a corresponding knowledge base Al of co-pilot 110. In some embodiments the corresponding knowledge base Al of co-pilot 110 is operative to set a rate for refreshes based on one or more datasets. These options can be beneficial particularly for datasets which have relatively simple structures. Automatically adjusting refresh rates or triggers for refreshes for different datasets can help to reduce system resource consumption during both dormant periods or runtime.

For example, consider a knowledge base related to user development work items. This type of knowledge base may need to be refreshed each time a change is made to a dataset that contains records of the work items. By contrast, a separate knowledge base containing weekly team summaries might only need to be updated once a week. As another example, requests relating to the current runtime of deployed software might require co-pilot 110 to obtain up-to-date data immediately (e.g. by issuing an immediate direct HTTP GET request) for the knowledge base to gather potential information that assists in completing a summary. The HTTP GET method is a request-response protocol in the client-server computing model, used to request data from a specified resource, often over the internet. A sample request might be a request to a backend server to obtain the latest ticket completed by a user.

In some embodiments, order to enhance the density of knowledge and reduce the proliferation of irrelevant information in knowledge bases of co-pilot 110, initial summaries are carried out using NLPs. These summaries can be valuable when previewing data and provide information which can assist in more efficient semantic searches. NLPs can also reduce the quantity of information the knowledge base requires to handle straight-forward queries. For instance, a query about information relevant to the topic of frontend development may first undergo a semantic search amongst all summarized information. Depending on the search quality, data may be directly returned or further searches with full text may be conducted. The system may also create periodic summaries utilizing knowledge base systems and present them to one or more users. These summaries may, for example include weekly work item reports, monthly user progress reports, and daily system performance summaries. System generated summaries may also assist with further querying.

In the system, related information from both new and existing data can be summarized and stored collectively. For example, a knowledge base system pertaining to user status might continuously accept incoming work item updates. For each update related to a specific work item, the system would subsequently update related entries, such as the designated user's progress summary, description, role, and history of prior tasks. This technique eliminates the need for large-scale summaries to be generated during runtime, thereby improving system efficiency, data interpretability, and the overall quality of output.

In some embodiments, instead of merely summarizing the data, preprocessing of a given knowledge base may be carried out to normalize the style or language used in its writing. This normalizes metrics, languages, such as English and French; tones, and entity names. Such normalization may facilitate the retrieval of more precise, accurate, and relevant information.

Various embodiments may implement knowledge bases in different ways. Some example ways to implement a knowledge base include:
one or more knowledge bases implemented by a selected LLM that is fine-tuned based on specific application data in order to create a custom LLM model. The resulting LLM may be optimized for specific needs of a given project and application.
one or more knowledge bases implemented by a generic LLM is used with information embedded into vector formats.

As user requests (queries) are received at UI 112, a knowledge base module of co-pilot 110 may determine which embedded content is the best match for the queries. Co-pilot 110 then presents that information to the user through UI 112.

In some embodiments, co-pilot 110 contains plural knowledge base systems so that it is able to assist in DevOps-related operations, such as DevOps administration, information extraction using NLP models, and other applications dealing with context-specific information in software development.

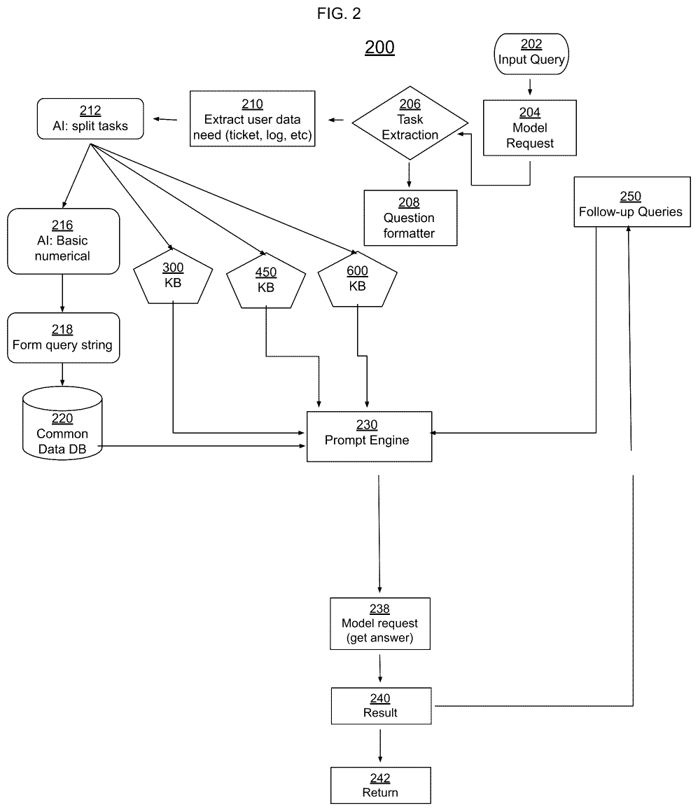

FIG. 2 shows an example system 200 that utilizes multiple knowledge bases (knowledge bases 300, 450 and 600) are shown. System 200 and its associated methods incorporate numerous Al pipelines, Al models, and data pipelines. System 200 integrates Al in order to perform numerous tasks using the knowledge contained in the system knowledge bases 300, 450, 600. These tasks may include, but are not limited to, querying and cross-referencing, learning by refining or fine-tuning existing knowledge, and reflecting and memorizing the knowledge contained within knowledge bases 300, 450, 600.

The integration of Al in a system as described herein facilitates managing information by inserting, deleting, and rearranging it. Such a system may also execute software components and conduct either asynchronous or synchronous training on a part, or the entirety of, the information contained within its knowledge bases. Intricate and complex processing ensures a comprehensive and highly responsive system, conducive to efficient and effective DevOps operations.

A co-pilot based system and associated methods as described herein may be context dependent or general purpose. By adjusting the relevant knowledge base or bases, such a system may handle queries specific to domains, organizations, teams, and different users. For instance, a system (e.g. system 200) as described herein may include knowledge bases containing specific knowledge that is unique to a specific undertaking (e.g. to a particular domain organization, team, project, software application etc.). This allows the system 200 to provide responses that are specific to a particular undertaking.

In some embodiments, the scope of the knowledge contained in a system 200 is solely focused on a particular project. In some embodiments, a system 200 includes one or more knowledge bases in which learnings from a plurality of different projects are combined into a larger knowledge base and then applied.

A system as described herein may incorporate proprietary and/or confidential regarding a certain undertaking. The system may be secured to permit access only by authorized users. Such a system may respond to private and internal questions, including, for example, questions about specific software structures, without the risk of data leaks.

A system as described herein is not limited to the field of software development and maintenance. A system as described herein may be applied to domains outside of software development. For example, it could be applied in other fields such as research, where the system may be leveraged to track and create reports on progress, or such a system could be configured and used in hardware projects to track work items and tickets.

Systems and associated methods as described herein may produce outputs that go beyond responses to information queries or text generation. In some embodiments, systems as described herein are configured to produce output that supports tasks such as: hardware interaction, service monitoring, etc. Consequently systems according to some embodiments of the technology described herein may be configured to produce outputs that aid in other productive tasks utilizing information stored in application or service databases.

For example, in some embodiments, a system as described herein serves as a computer programming aid. Programming assistance provided by such a system may be specific to the context of a current undertaking. For example, by studying software structure in work items, the system can aid a user in programming software that matches, or is similar to, the existing structure.

Systems according to some embodiments are highly configurable. Such systems may be capable of adjusting their algorithm based on specific user requests and requirements. Systems according to some embodiments are configured for specific latency requirements in order to choose faster or more accurate algorithms in cases where performance trade-offs must be made.

Systems as described herein may be implemented by configuring various data pipelines and instructing them to collect data from software DevOps management platforms, such as Microsoft Azure DevOps™. The system may then populate various databases with information, including that pertaining to software work items, software deployment and release, and communication history between software engineers.

Systems as described herein may be capable of responding to complex multimedia user queries regarding a project or organization's software DevOps process.

Turning back to FIG. 2, system 200 includes four main sections and numerous sub-modules, and it encompasses multiple internal iterations between these. These sections include UI section 430, communication section 440, task extraction, user data extraction and task splitting sections 206, 210 and 212, knowledge base sections 216, 300, 450 and 600, and backend communication module 204.

UI and communication sections 430, 440 comprise software and hardware systems configured to bridge between user input and the co-pilot. The UI section 430 may support user input from multiple sources, including keyboard, voice, and camera input, or the porting of queries from external storage devices. Communication module 440 is configured to normalize inputs into supported formats for different knowledge bases, such as converting a voice file to text.

Task extraction and splitting section (206, 210 and 212) serves to analyze user entries and differentiate the type of questions being asked. The processing also ascertains the internal system components required to address such queries and establishes a sequence for execution of these components in order to provide the most accurate response. The extraction of these tasks can be accomplished through methods such as keyword matching, user specification, NLP techniques, randomness, or a combination of these methods. For instance, a query seeking numerical information might be processed differently from a query about a specific work item, such as work items referenced in knowledge bases 216 or 300.

Task extraction system 206 may optimize user inputs by reducing their length through summarization, or enhancing their clarity through rewording. This could potentially be achieved through compression methods, or by applying NLP techniques.

To address the issue of indistinct user queries, where a single search term might correspond to multiple entities stored in a knowledge base or bases, an approach involving special preprocessing which utilizes another knowledge base system can be employed. This auxiliary system is designed to differentiate between the entities and determine which one the user intends to query.

For example. consider a scenario where the user conducts a search using the first name of an individual, such as “Guan.” In the knowledge base, there might exist multiple individuals with the first name “Guan,” such as “Guan Huang” and “Guan Blue.” Consequently, without additional information, it may be challenging to discern which “Guan” the user wants to find.

This is where an additional knowledge base comes into play. The additional knowledge base contains user roles and general summaries, linked with unique user identifiers (UIDs). This additional knowledge base may be queried to leverage additional context, parts of the query, and timings relevant to the user, to help differentiate between the several “Guan” entities available. In this way, the system is able to effectively sift through possible entities to return the UID most relevant to the user's query.

Such a user entity knowledge base system may collect information regarding user roles when they sign up for the service, or it may attempt to distinguish their roles by analyzing their regular activity, such as their work item progress or documentation. Answers returned by the system can be tailored to a user's profile. For example, to a frontend engineer with specific software technology stack skills.

Knowledge base sections (e.g. 300, 450, 600) are designed to handle different types of user tasks. Knowledge bases may, for example, include some or all of a deployment information knowledge base, a work item knowledge base, a numerically optimized work item knowledge-base, a sentiment optimized software logs knowledge base, a technical document knowledge base, a software release knowledge base, a user status and summary knowledge base, and a general purpose knowledge base.

Depending on the system configuration, a multi-tiered data protection protocol may be enforced. This ensures that queries raised by individuals with insufficient credentials are not able to access, or otherwise have restricted access, to protected data. This data security mechanism may be integrated at the knowledge base level, preprocessing, post-processing, and Al formatting stages.

A system as described herein may be configured to support specification of the type of data to be protected. This specification may be provided through natural language input. This feature significantly enhances data security by prohibiting access to sensitive data categories such as addresses and access credentials, preventing potential data leaks. The system can also be used to prevent private data from being included in the knowledge base. Depending on the setting, private data, such as address, may be replaced with an empty identifier <ADDRESS> to ensure the quality of data processing by the system.

Multiple knowledge bases may be utilized to process a single request, depending on the complexity and nature of the request. As an illustration, to acquire software details, the system might require information from both a work item knowledge base and a technical document knowledge base.

In some embodiments, output from one knowledge base may be used as query input for another knowledge base. Consider the query, “Who created the most recent work item pertaining to frontend development?” To handle the above question, a query is issued to a sentiment-optimized work item knowledge base to find all frontend-related questions. Then a query to find the author of all returned work items is issued to a numerically optimized work item knowledge base. Finally, a query to user status and summary knowledge bases could be used to obtain a detailed description of the author.

A response formation section determines output formats and assembles multiple results if necessary. This section may, for example include a data post-processing module, a control module, which controls certain actions such as “Create New Work Item;” and a NLP module, which assembles the retrieved knowledge and formats it into a logical natural language response. The post-processing module may be implemented using another knowledge base system that uses relevant information to inspect and modify the previous output. If the system identified a name that corresponds to two entities, the output could be reformatted to include UID for clarification, mirroring the preprocessing step discussed above. This type of system can also serve to strengthen data security by preventing sensitive information leaks, such as user emails, URLs, or any other unrelated low security data.

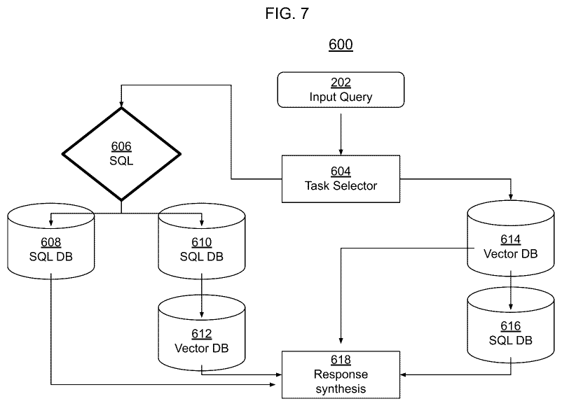

The example component modules of a system 600 according to one embodiment are shown in FIG. 7 which also illustrates related methods. At 202, a question is asked by a user, which the knowledge base system will attempt to answer. At task selector 604, an LLM is prompted to classify the query as one that can be answered with either Structured Query Language (SQL) or a semantic vector database search. If SQL is selected, one or more SQL queries are generated at 606. The SQL query or queries are then executed on SQL databases 608, and 610. Otherwise, the vector database is selected and vector database 614 and SQL database 616 are searched. The results of the searches (e.g. relevant tickets or context) are passed onto response synthesis 618.

Block 606 may generate the SQL query or queries by prompting a LLM to generate a SQL query to answer the initial input question. In this prompt, it is also specified that, if the input query in step 602 can be directly answered via a SQL query, then a SQL query is generated and executed on SQL database 608. If a question cannot be directly answered by a SQL query, a SQL query is generated and executed on SQL database 610. This SQL query retrieves relevant ticket IDs needed to answer the input question. In response to receiving results from the search of SQL database 610, a search of vector database 612 is performed. The search of vector database 612 may comprise a nearest-neighbors vector search, with respect to the embedded input query, filtering only for the IDs retrieved from SQL database 610.

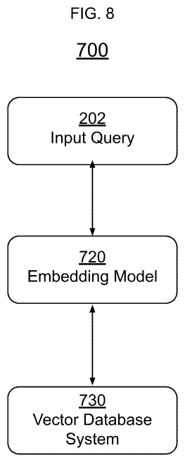

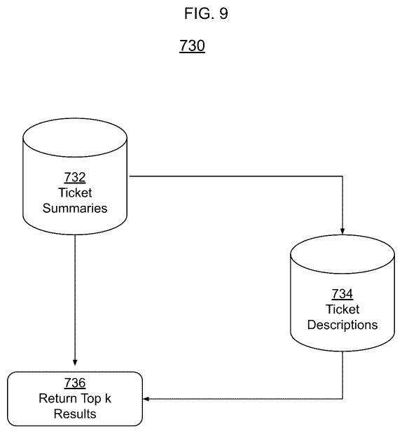

In the case where the query requires a vector search, of vector database 614, the input query is embedded (see FIG. 8 at block 720) and a nearest-neighbors vector search is performed (see FIG. 8 at block 730). The top n tickets in the results from the vector search are passed onto response synthesis block 618. The cosine similarity scores from the vector search of database 614 are thresholded, and the tickets above a specified threshold are placed in a SQL table. The specified threshold could be an automatic predefined value, set by the user, or dynamically adjusted based on the chat history or particular queries. The LLM is then prompted to generate a SQL query to organize and retrieve the top k tickets needed to answer the input question (see FIG. 9 at 736). The top tickets are then passed on.

FIGS. 8 and 9 illustrate a method for performing a vector search. Block 730 applies a vector database system, encompassing two vector databases. One database 732, contains the embedded ticket summaries. Another database 734, contains the embedded ticket descriptions. To search these databases, the input question is first embedded via an embedding model at block 720. Then, an approximate nearest-neighbor algorithm is performed to retrieve the cosine similarity scores between the input query and the nearest embedded ticket summaries. It is to be understood that other similarity methods are equally possible. At block 736, the top k results are returned. If the top cosine similarity scores are low, then this procedure may be repeated with the embedded ticket descriptions and the result from the ticket descriptions database in step 734 is returned instead.

Response synthesis block 618 receives the input question. The context retrieved as a result of blocks 606, 608, 610, 612, 614, and 618; is passed into an LLM with a prompt to synthesize the information and answer the input question. The LLM's response is then presented to the user using a natural language processing model.

In some embodiments, systems as described herein use a combination of SQL queries and Vector Similarity searches to return ticketing information relevant to some user input question (paths 606 and 614). Similarity searches are helpful for finding semantically similar information. i.e., tickets related to some specific topic. SQL queries are most useful for performing arithmetic operations and searching for information in specific date ranges, which LLMs can struggle with when unassisted.

A problem faced by this type of system comes from deciding when, and in which order, it should perform a semantic search or generate a SQL query. This embodiment attempts to solve that problem by performing both tasks simultaneously. This reduces the complexity of the system and provides more accurate context retrieval. By adding semantic scores to the SQL table being queried, this embodiment can perform a vector-like search within the same SQL query. This allows it to filter by additional parameters, like date, employee name, etc.

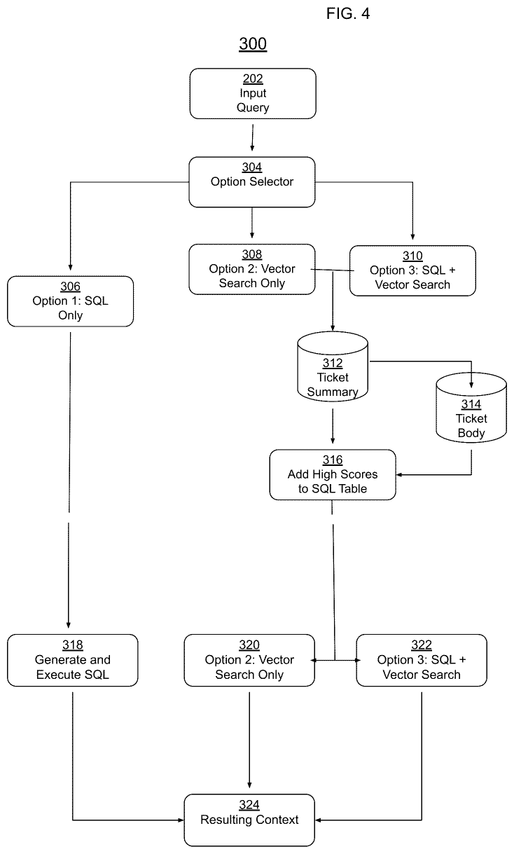

FIG. 4 illustrates an example method 300. The user enters an input query at block 202. Subsequently, in step 304, the query is put through an option selector, which determines which branch of the system to execute. In this step the language model used by the system is asked to choose a suitable option given the input query. In this example there are three options available to the system, which may choose to proceed to perform step 306, step 308, or step 310.

Step 306 is ideal for questions that only require a SQL filter and are not related to the content of the tickets. Questions in this format may, for example, include filtering by date, counts, or employee name. These types of questions do not require vector searches.

Step 308 is chosen when a question only requires a semantic search. such as finding tickets or work items related to some specific topic. This does require a vector search, but no SQL filter.

Step 310 is executed when a user question requires both a semantic search and a SQL filter. This is the broadest of the three methods. Questions in this format are some combination of numerical and semantic, as illustrated previously. For these types of questions, it can be important to provide several examples in the prompt to help the LLM understand a given question. Once step 304 is complete, the system executes the appropriate path.

Step 306 prompts the LLM to generate a SQL query to retrieve relevant information. The prompt includes a description of the task, information about the SQL table to filter, some basic information about the data, and the input query for which to retrieve the information.

In some embodiments, a system as described herein is configured to use a hybrid approach for retrieving both structured and unstructured information. In such embodiments a SQL search strategy is combined with a vector search methodology. This facilitates representing complex structured and unstructured data in a way that allows the data to be accessed using SQL queries generated by the LLM.

As an example of this hybrid approach, consider the case where an answer to a user question requires information about a software application that may be found in ticket data, log data and build information for the software application. Ticket data includes highly structured elements such as dates, status, priority, various tags and also includes free-form text (title, body, comments). Logs can have a variety of structuring and syntax. Build information is quite structured with specific tickets and included code.

The hybrid approach involves prompting the SQL-generator (e.g. LLM) to include in a SQL query a “relevance” field, which identifies “semantic” (or unstructured) type queries:

In response to a user question, the LLM is prompted to generate a SQL query to retrieve data needed to answer the question. The SQL-generation prompt can include the “relevance” field and instruct the LLM to use the relevance field for ordering results, whenever a semantic search is appropriate.

For example, if the user question is: “Did we have any bug tickets related to Large language models in 2023?”. The LLM may generate the SQL query: “SELECT*FROM [tickets_table] WHERE YEAR ([CreatedDate])=2023 AND [Type]=‘Bug’ ORDER BY relevance_to_question”. Where, as in this example, the SQL query includes a relevance field (the “ORDER BY” statement), a vector search may be automatically triggered. Results of the vector search may then be filtered according to the SQL conditions in the SQL query

In steps 720 and 730 (FIG. 8) the system performs a vector search on the vector database containing embeddings of ticket summaries and/or descriptions. After the similarity scores for a top k number of items has been determined in step 736, the scores are inserted into the SQL table containing ticket data organized in the appropriate location. This allows for a SQL query to be ordered with a similarity score which allows the user to perform a vector search with a SQL table.

Step 310 is performed when both a SQL filter and semantic search are necessary to retrieve the most relevant contextual information. As in step 308, a vector search is performed on the ticket summaries and/or descriptions and the returned scores are inserted into the SQL table. the LLM is then prompted to generate a SQL query which performs any necessary filters. The query is ordered by semantic similarity score. After the SQL query has been generated, the SQL query is executed and the results, as well as the input query, are forwarded to the LLM which synthesizes the context and input question into a satisfactory answer for the user.

The system combines the results of the two searches described above through an assemble method. If the results from step 306 and step 308 are the same, there is no need to do anything further. If the results differ, the two answers can be queried to determine which is the more appropriate answer to return to the user using an LLM. The same LLM may be used in two searches described above, but ideally using another independent LLM. Additionally, if multiple co-pilot query answers returned are different, the system could prompt the user for more information.

The UI provides a way for users to interact with the knowledge base. The UI may take any of many forms including, for example, a keyboard and mouse on a computer, tablet or mobile device; a voice-to-text system; a camera or some other means of communication. Likewise, responses to user queries, may be displayed on a screen, read-aloud technology, or other methods.

In one embodiment of the present invention, a knowledge-based co-pilot assists software development teams by answering operator questions and queries through the analysis data from a variety of data sources. The co-pilot then formulates a logical response by analyzing relevant information. The response is then presented to the user through a graphical user interface (UI). The questions and queries can take a variety of forms including numerical queries like, “How many tickets did developer x close last week?” Queries may also be asked in the form of semantically related questions, such as, “Who should I talk to about a bug with payment implementation?” In addition, queries can be open-ended questions like, “Who is the best programmer? Justify,” or “Which ticket caused the most recent bug?” which can aid in finding solutions which utilize different information types or may not be apparent to operators or previously developed co-pilot systems.

Systems and methods according to the present technology can be well suited for working with large projects containing thousands of work items, which may be related to different functional areas in the code o a software application. Understanding the relationships between the different tickets would be difficult to accomplish manually, not only because of the complexity of the information, but also due to the sheer number of tickets which would need to be examined, as well as the number of distinct users that could have contributed to the code base. A system as described herein can automatically identify such relationships and present them to users.

In some embodiments a system is configured to suggest follow-up information or related queries resulting from information specified by the user. For instance, if a user presents the system with a specific piece of software the system may attempt to ask challenging questions or suggest improvements to the algorithm based on existing information. Such information can come from a work item describing similar software, or by inspecting previous bug fixes related to similar software.

In some embodiments a system is configured to continuously suggest related or more specific information for the user to respond to. This approach may be taken when a user responds to, or asks queries without providing any concrete rules. With each iteration learning from the previous response, the system will eventually arrive at the user's latent inclination. For instance, a user requires a weekly report of their own progress, including work items, comments, and replies, but does not need all work to be displayed. Using a knowledge base system, the user can first specify a range of time and constantly select what is relevant, and the system will quickly learn from their responses and help to select all relevant tickets.

In some embodiments a system is configured to create, suggest, modify, or improve existing data inside its knowledge base system by processing all of the information contained in the knowledge base, with or without the additional input from user queries. For example, the system may automatically create work items, based on tickets contained in a given knowledge base, which would match the previous format.

In some embodiments, a knowledge base system is attached to other Al models so that it may function as a verbal DevOps command terminal. The resulting terminal may be connected to direct the work of a cluster of Al. Given that Al often documents its progress in machine code or technical language, it is possible to create an overarching knowledge base system designed to decode this progress and present it to the user for reporting purposes or for further instruction. This process enables multi-source data management, including the review and organization of information originating from various sources, reports, and Al models. The system may be equipped to carry out dynamic analyses of Al reports, issue alerts to the user related to Al execution progress, and possibly initiate the creation of new task items for execution by the knowledge base system, with and without user intervention.

In some embodiments, a system is configured to generate a history of users who have made modifications in a specified area of code, including those who may no longer be associated with a project or organization. The system can be asked to generate similar requests or return specific queries at regular intervals. For example, “return me the most critical bugs created this week and return me the answer each Friday at noon”. The system may be configured to incorporate external information to help improve the quality of the results. For example information during the onboarding process can be used to standardize data inputs to account for companies using different development practices or naming conventions etc. (for example “bug” vs “issue” etc). This could either be automatic, where the system ingests the data and key information such as naming conventions and mappings are passed to the knowledge bases and language models. Then when new companies are onboarded, the learnings about naming conventions and data mappings can be leveraged across organization/projects etc. As the number of companies or projects using the system increases, most common data mappings and conventions should have been encountered, and therefore new company or project onboarding should encounter less potential data mapping issues. External data sources such as HR databases databases with names, skills, function etc. of employees or other information can be incorporated into the knowledge bases to help improve system query results.

Where a component (e.g. a software module, processor, database, assembly, device, circuit, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Systems according to embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

The invention may also be provided in the form of a program product. The program product may comprise any non-transitory medium which carries a set of computer-readable instructions which, when executed by a data processor, cause the data processor to execute a method of the invention and/or to provide all of or one or more components of a system according to the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, code for configuring a configurable logic circuit, applications, apps, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Software and other modules may reside on servers, workstations, personal computers, tablet computers, and other devices suitable for the purposes described herein.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. An automated system for responding to user questions with information from one or more knowledge bases, the system comprising:
one or more data processors configured to provide:
a machine learning model configured to receive user questions and, in response to each user question:
determine whether answering the user question requires unstructured data from the one or more knowledge bases and determining whether answering the user question requires structured data from the one or more knowledge bases;
if the machine learning model determines that answering the user question requires structured data, generating a search strategy including at least one search query for retrieving from the one or more knowledge bases structured data relevant to the user question; and,
a database system controlled to, in response to the determination that answering the user question requires structured data, execute the search strategy to retrieve a set of data items that satisfy the search strategy from the one or more knowledge bases;
a vector search system controlled to, in response to the determination that answering the user question requires unstructured data, perform a vector search of unstructured data included in data items in the one or more of the knowledge bases, generate similarity scores that indicate a degree of similarity of the unstructured data in the data items to the user question and retrieve a set of data items for which the similarity scores satisfy a criterion;
a response generator configured to generate and output an answer to the user question based on the set of data items that satisfy the search strategy if the machine learning model determined that answering the user question requires structured data and based on the set of data items for which the similarity scores satisfy a criterion if the machine learning model determined that answering the user question requires unstructured data.

2. The system according to claim 1 wherein the machine learning model comprises a large language model (LLM).

3. The system according to claim 1 wherein the machine learning model is configured to output an unstructured data indication in response to determining that answering the user question requires unstructured data.

4. The system according to claim 3 wherein the unstructured data indication comprises a command included in the search strategy.

5. The system according to claim 1 wherein the response generator comprises a second machine learning model and the answer to the question is a natural language answer.

6. The system according to claim 5 wherein the second machine learning model comprises a LLM.

7. The system according to claim 1 wherein the search strategy comprises a sequence of search queries.

8. The system according to claim 7 wherein the sequence of search queries includes a search query that comprises one or more results from a result set of a previous search query in the sequence of search queries.

9. The system according to claim 1 wherein the database system is configured to use the similarity scores to sort the data items of the set of data items retrieved by the database system.

10. The system according to claim 1 wherein the one or more search query. comprises one or more Structured Query Language (SQL) queries.

11. The system according to claim 1 wherein the vector search is performed on the data items of the set of data items retrieved by the database system.

12. The system according to claim 1 wherein the vector search system is operated to add the similarity scores to a SQL table.

13. The system according to claim 1 wherein the knowledge bases comprise one or more of: a dataset containing tickets and work items, a dataset containing application logs, a dataset containing build information, a dataset containing environment information, a dataset that contains software library information, a dataset containing source code, and a dataset containing information regarding compute resources, a work item knowledge base and a technical document knowledge base.

14. The system according to claim 1 wherein the knowledge bases contain data items that relate to development of a computer software application.

15. The system according to claim 14 wherein the data items of the knowledge bases include a complete history of the state of the software application and all work done in the development and maintenance of the software application.

16. The system according to claim 1 wherein the system is configured to generate summaries of data items in the one or more knowledge bases.

17. The system according to claim 1 wherein the system is configured to normalize a style and/or language of data items of the data sources.

18. The system according to claim 1 wherein, if the machine learning model determines that answering the user question requires structured data and unstructured data, the vector search system and the database system search are controlled to perform the vector search and to execute the search strategy in parallel.

19. The system according to claim 1 wherein the system is configured to pass a number, n, of data items of the a set of data items for which the similarity scores satisfy a criterion to the response generator.

20. A method for automated response to user questions with information from one or more knowledge bases, the method comprising:
receiving a user question,
in response to each user question, automatically determining using a trained machine learning model whether answering the user question requires unstructured data from the one or more knowledge bases and determining whether answering the user question requires structured data from the one or more knowledge bases;
if answering the user question requires structured data, generating a search strategy including at least one search query for retrieving from the one or more knowledge bases structured data relevant to the user question and executing the search strategy to retrieve a set of data items that satisfy the search strategy from the one or more knowledge bases;
if answering the user question requires unstructured data, embedding the user question and performing a vector search of unstructured data included in data items in the one or more of the knowledge bases, generating similarity scores that indicate a degree of similarity of the unstructured data in the data items to the embedded user question and retrieving a set of data items for which the similarity scores satisfy a criterion;
generating an answer to the user question based on the set of data items that satisfy the search strategy and/or the set of data items for which the similarity scores satisfy a criterion.
